(19) United States
(12) Patent Application Publication
(10) Pub. No.: US 2015/0377378 A1
(43) Pub. Date: Dec. 31, 2015

(54) A MAGNETIC VALVE WITH AN ARMATURE ARRANGED INSIDE A PISTON

(71) Applicant: DANFOSS A/S, Nordborg (DK)

(72) Inventors: Michael Birkelund, Middelfart (DK); Johan van Beek, Almind (DK)

(73) Assignee: Danfoss A/S, Nordborg (DK)

(21) Appl. No.: 14/766,488

(22) PCT Filed: Jan. 3, 2014
(86) PCT No.: PCT/DK2014/050001

§ 371 Date: Aug. 7, 2015

(30) Foreign Application Priority Data
Feb. 11, 2013 (DK) PA 2013 00080

(51) Int. Cl. F16K 31/06; F16K 3/02

(52) U.S. Cl. CPC F16K 31/0668; F16K 3/0218; F16K 31/0648

(57) ABSTRACT

A magnetic valve (1) comprising a valve housing (2) defining an inlet opening (3) and an outlet opening (4), a valve seat (11), a valve closing element, and an armature tube (7) is disclosed. A piston (6) is arranged movably inside the armature tube (7), said piston (6) being connected to the valve closing element, and an armature (5) is arranged movably at least partly inside the piston (6). A coil (9) is arranged externally to the armature tube (7) in such a manner that at least a part of the armature (5) arranged inside the piston (6) is arranged inside the windings of the coil (9).

### CROSS-REFERENCE TO RELATED APPLICATION

This application is entitled to the benefit of and incorporates by reference subject matter disclosed in the International Patent Application No. PCT/DK2014/050001 filed on Jan. 3, 2014 and Danish Patent Application PA 2013 00080 filed Feb. 11, 2013.

### FIELD OF THE INVENTION

The present invention relates to a magnetic valve, such as a solenoid valve. The valve according to the invention is compact and provides good guidance for a piston arranged movably in an interior part of the valve.

### BACKGROUND

Magnetic valves normally comprise an armature tube accommodating a movable armature being made from a soft magnetic material, i.e. a material which becomes magnetic when subjected to a magnetic field, e.g. provided by a coil being energized. A coil is arranged around the armature in such a manner, that when the coil is energized, i.e. an electrical current is supplied to the windings of the coil, a magnetic field is induced in the armature, causing the armature to move along an axial direction inside the armature tube.

Magnetic valves further comprise a valve housing accommodating a valve seat and a valve closing element being movable between a position in which it abuts the valve seat and positions in which it does not abut the valve seat. The valve closing element may be connected to or form part of a piston arranged movably in an interior part of the valve, and/or it may be connected to the armature in such a manner that movements of the piston and/or the armature, due to energizing or de-energizing the coil, causes movements of the valve closing element between abutting and non-abutting positions. When the valve closing element is not arranged in abutment with the valve seat, the valve is open and a flow of fluid through the valve from an inlet opening to an outlet opening is allowed. When the valve closing element is arranged in abutment with the valve seat, the valve is closed and a flow of fluid through the valve is prevented. Thus, the valve can be opened and closed by controlling a supply of electrical current to the coil.

U.S. Pat. No. 6,021,997 discloses a proportional power control valve including a solenoid controlling a main piston. The main piston cooperates with a servo-control piston to block the valve intake from the valve outlet. The servo-control piston is part of a cylindrical armature controllable by an electromagnet of the solenoid. The servo-control piston, which is arranged inside the main piston, forms a separate part which is attached to the armature, i.e. the part which is controlled by the electromagnet.

### SUMMARY

It is an object of embodiments of the invention to provide a magnetic valve which is compact along a longitudinal direction.

It is a further object of embodiments of the invention to provide a magnetic valve which operates precisely without requiring fine manufacturing tolerances.

The invention provides a magnetic valve comprising:
a valve housing defining an inlet opening and an outlet opening,
a valve seat arranged in an interior part of the valve housing,
a valve closing element arranged in an interior part of the valve housing, said valve closing element being movable relative to the valve seat, in such a manner that the position of the valve closing element relative to the valve seat determines a flow of fluid through the valve from the inlet opening to the outlet opening, via the valve seat,
an armature tube,
a piston arranged movably inside the armature tube, said piston being connected to the valve closing element,
an armature arranged movably at least partly inside the piston, and
a coil arranged externally to the armature tube in such a manner that at least a part of the armature arranged inside the piston is arranged inside the windings of the coil.

The valve according to the invention comprises a valve housing. In the present context the term ‘valve housing’ should be interpreted to mean a substantially closed structure defining an outer boundary of the valve and an interior part, through which fluid flows during normal operation of the valve, at least when the valve is in an open position. The valve housing defines an inlet opening and an outlet opening. During operation fluid enters the valve via the inlet opening, flows through the interior of the valve housing, and leaves the valve via the outlet opening. This will be described further below.

The valve further comprises a valve seat and a valve closing element. The valve seat is arranged in an interior part of the valve housing. The valve closing element is movable relative to the valve seat in such a manner that the position of the valve closing element relative to the valve seat determines a flow of fluid through the valve from the inlet opening to the outlet opening. The valve closing element may be movable between a position in which it abuts the valve seat, thereby closing the valve, and positions in which it does not abut the valve seat, thereby opening the valve. In the closed position, fluid is prevented from passing through the valve from the inlet opening to the outlet opening. In the open position, fluid is allowed to pass through the valve from the inlet opening to the outlet opening, via the valve seat. The exact position of the valve closing element, relative to the valve seat, may define an opening degree of the valve.

The valve further comprises an armature tube, and a piston is arranged movably inside the armature tube. The piston is connected to the valve closing element. Thereby the position of the piston determines the position of the valve closing element relative to the valve seat, and thereby the fluid flow through the valve.

An armature is arranged movably at least partly inside the piston. In the present context the term ‘armature’ should be interpreted to mean a part of the valve which conveys magnetic flux when the magnetic valve is energized, and which is movable as a result of the magnetic field which is created when the magnetic valve is energized. Thus, a part which conveys magnetic flux is arranged inside the piston.

A coil is arranged externally to the armature tube in such a manner that at least a part of the armature arranged inside the piston is arranged inside the windings of the coil. Thus, the armature, the piston and the coil are arranged relative to each other in such a manner that at least part of the armature is surrounded by at least part of the piston, which is again surrounded by at least part of the coil. Accordingly, magnetic flux travels from the coil, through the piston to the armature. This arrangement of the armature, the piston and the coil allows the valve to be constructed in a very compact manner, because the armature and the piston need not be arranged end to end relative to each other. Furthermore, it is possible to provide a relatively long piston, without having to increase the size of the valve, because the piston is simply arranged between the armature and the armature tube. A long piston ensures that the armature tube is capable of guiding the piston in an accurate manner, without requiring fine manufacturing tolerances of the parts of the valve. This ensures accurate operation of the valve, while keeping the manufacturing costs low.

The piston and the armature cooperate in controlling the fluid flow through the valve. Thus, when the coil is energized or de-energized, thereby causing movements of the armature inside the piston, the valve closing element is also moved. Accordingly, the valve can be opened and closed by controlling the energy supply to the coil, thereby energizing and de-energizing the coil.

The valve may be a solenoid valve.

Alternatively or additionally, the valve may be a proportional valve. In the present context the term ‘proportional valve’ should be interpreted to mean a valve in which the magnetic flux passing through the armature depends on the position of the armature, and thereby on the opening degree of the valve. This may, e.g., be obtained by designing the armature in a suitable manner. In proportional valves abrupt movements of the armature are prevented, and a smooth operation of the valve, e.g. between a closed position and an open position, is obtained.

The valve may further comprise an armature top arranged to close an end part of the armature tube. The armature top may be fitted to the armature tube in a sealing manner, e.g. by means of a snap fit connection, it may be welded onto the armature tube, or it may be mounted in any other suitable way.

The armature top may have an end part facing the armature, said end part having a substantially conical shape arranged to be received in a mating conical recess formed in the armature. According to this embodiment, when the armature is moved during operation in response to the coil being energized, an increasing portion of the conically shaped end part of the armature top is received in the conical recess of the armature. Thereby an increasingly thick portion of the armature is moved into the windings of the coil, and the magnetic flux supplied to the armature thereby depends on the position of the armature. Accordingly, this design of the armature and armature top is an example of a design which results in the valve being a proportional valve.

The armature may be substantially enclosed by the piston. According to this embodiment the entire armature is arranged inside the piston. This may, e.g., be obtained if a side wall of the piston facing an inner wall of the armature tube is longer than the armature. Thereby a very compact valve is obtained. As an alternative, part of the armature may be arranged outside the piston, e.g. protruding from the piston.

The armature may be made from a soft magnetic material. In the present context the term ‘soft magnetic material’ should be interpreted to mean a material which becomes magnetic only when subjected to a magnetic field. Thereby the magnetic flux generated by the coil can pass through the armature.

The piston may have a length along an axial direction of the armature tube, which is longer than a transverse size of the piston. According to this embodiment, the part of the piston which follows the armature tube is long compared to the size of the piston along a direction which is perpendicular to the axial direction. This ensures a good guidance of the piston by the armature tube during movements of the piston along the axial direction, because tilting and wiggling of the piston is minimised. Furthermore, it is possible to design the piston in this manner without increasing the overall size of the valve, because the armature is arranged at least partly inside the piston as described above.

The valve may further comprise mechanical biasing means biasing the valve closing element in a direction towards or away from the valve seat. The mechanical biasing means may be or comprise a spring, such a compressible spring or a torsion spring. Alternatively, the mechanical biasing means may be or comprise other suitable devices which are capable of biasing or pushing the valve closing element towards or away from the valve seat.

In the case that the mechanical biasing means is biasing the valve closing element in a direction towards the valve seat, the valve closing element will be arranged in abutment with the valve seat when the coil is de-energized, and the valve will be in a closed position. Energizing the coil will, in this case, cause the valve closing element to move away from the abutment position, thereby opening the valve. Such a valve is sometimes referred to as a ‘normally closed’ or NC valve.

In the case that the mechanical biasing means is biasing the valve closing element in a direction away from the valve seat, the valve closing element will not be arranged in abutment with the valve seat when the coil is de-energized, and the valve will be in an open position. Energizing the coil will, in this case, cause the valve closing element to move towards the valve seat and into abutment with the valve seat, thereby closing the valve. This, of course, requires that the force applied to the valve closing element when the coil is energized operates against the biasing force. Such a valve is sometimes referred to as a ‘normally open’ or NO valve.

A side wall of the piston facing an inner wall of the armature tube may be provided with one or more flow restricting structures. During operation of the valve, some fluid will flow along an outer wall of the piston, between the piston and an inner wall of the armature tube. By providing the side wall of the piston with one or more flow restricting structures, the fluid flowing between the piston and the inner wall of the armature tube is alternatingly accelerated and decelerated. Thereby a pressure drop is introduced, and the fluid flow along the piston and the inner wall of the armature tube is reduced. This is in particular an advantage in the case that the piston is provided with a pilot orifice, as described below. In order to ensure that the valve is opened when the pilot orifice is opened, the cross sectional area of the pilot orifice must be sufficiently large as compared to the fluid flow along the piston and the inner wall of the armature tube, to obtain a required pressure equalization when the pilot orifice is opened. Thus, by limiting or restricting the fluid flow along the piston and the inner wall of the armature tube, the cross sectional area of the pilot orifice can be reduced correspondingly. Thereby a lower force is required in order to operate the valve, and the size of the armature, the armature top and the coil can also be reduced.

The flow restricting structure(s) may be provided by a surface pattern formed in the side wall of the piston. The surface pattern may comprise raised and depressed surface portions forming the flow restricting structure(s). For instance, the surface pattern may be a helical pattern, e.g. resembling a thread.

The piston may be provided with a pilot orifice allowing fluid to pass between the outlet opening and the part of the piston where the armature is arranged. According to this embodiment, the valve may, e.g., be operated in the following manner. The valve is in a closed position when the coil is de-energized, i.e. the valve is of a normally closed (NC) type. When it is desired to open the valve, the coil is energized. Thereby the armature is moved inside the piston, thereby opening the pilot orifice, and allowing fluid to pass between the interior of the piston, where the armature is arranged, and the outlet opening. Accordingly, pressure equalization between these two regions is obtained. As a consequence, the higher pressure at the inlet opening causes the piston to move, thereby moving the valve closing element out of abutment with the valve seat, and opening the valve. According to this embodiment the force required in order to operate the valve is reduced, because the required force is proportional the cross sectional area of the orifice which is opened when the coil is energized. Therefore, when a small pilot orifice is opened, instead of the main orifice, a lower force is required. Thereby it is also possible to reduce the size of the armature, the armature top and the coil.

### BRIEF DESCRIPTION OF THE DRAWINGS

The invention will now be described in further detail with reference to the accompanying drawings in which

FIGS. 1 and 2 are cross sectional views of a magnetic valve according to an embodiment of the invention, in a closed position,

FIGS. 3 and 4 are cross sectional views of the magnetic valve of FIGS. 1 and 2, in a closed position with a pilot orifice open, and

FIGS. 5 and 6 are cross sectional views of the magnetic valve of FIGS. 1-4, in an open position.

### DETAILED DESCRIPTION

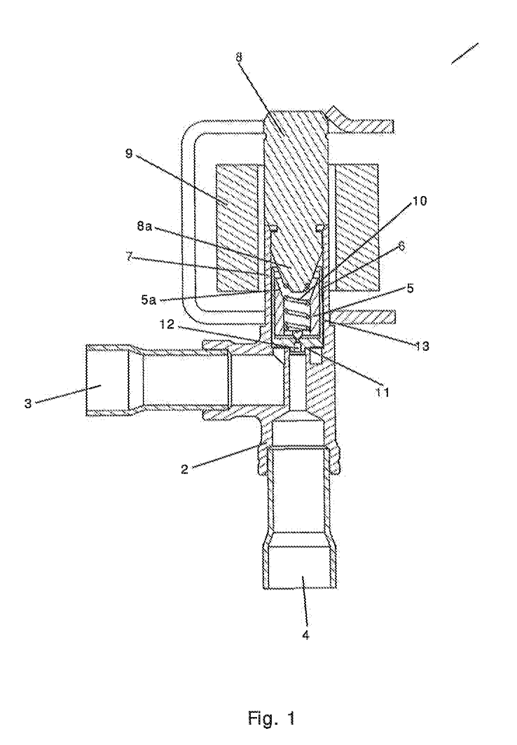

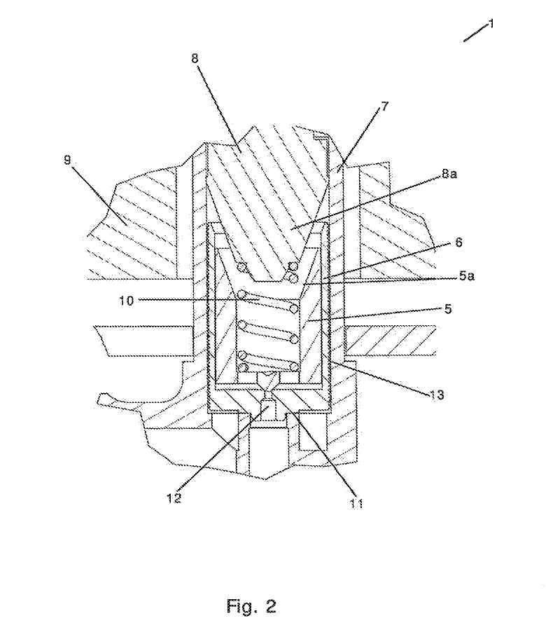

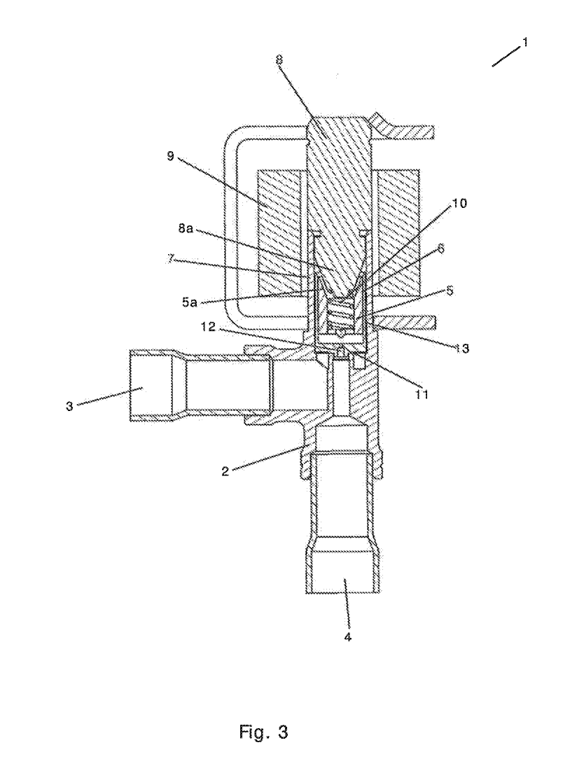

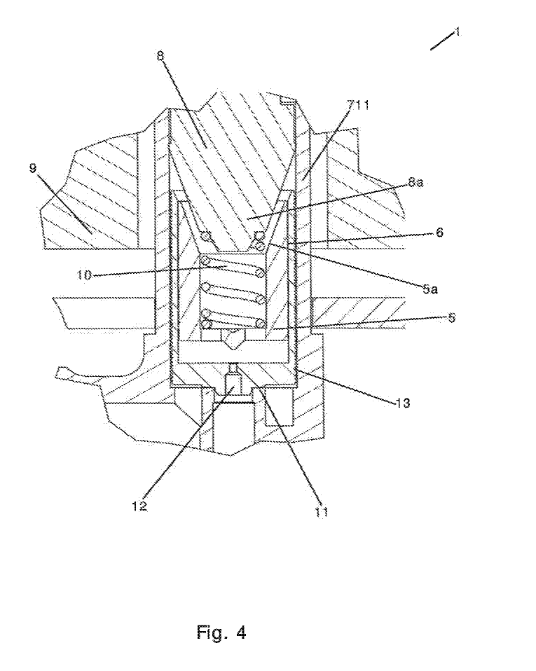

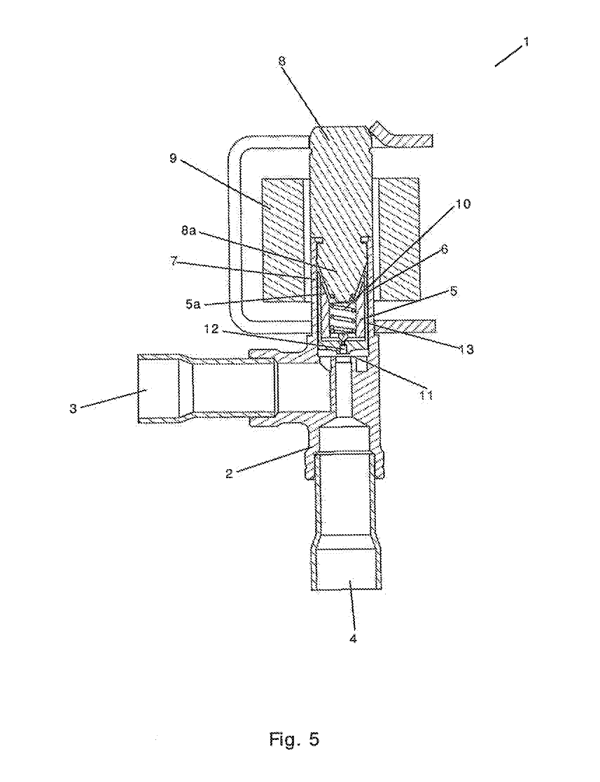

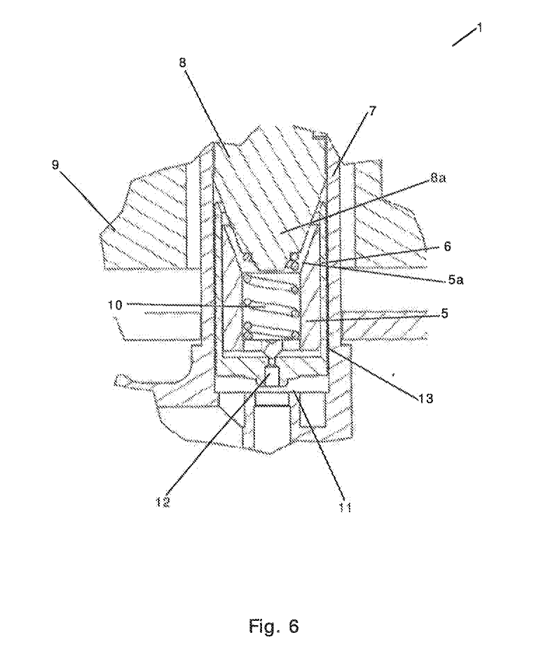

FIGS. 1-6 are cross sectional views of a magnetic valve 1 according to an embodiment of the invention. In FIGS. 1 and 2 the valve 1 is shown in a closed position, in FIGS. 3 and 4 the valve 1 is shown in a closed position with a pilot orifice open, and in FIGS. 5 and 6 the valve 1 is shown in an open position.

The valve 1 comprises a valve housing 2 defining an inlet opening 3 and an outlet opening 4. The valve 1 further comprises an armature 5 arranged inside a piston 6 which is arranged inside an armature tube 7. An armature top 8 is mounted on the armature tube 7 in such a manner that it closes an open end part thereof. A coil 9 is arranged exterior to the armature tube 7. A spring 10 is arranged inside the armature 5, biasing the armature 5 and the piston 6 in a direction towards a valve seat 11. A pilot orifice 12 is formed in the piston 6, providing a fluid passage between the interior of the piston 6, where the armature 5 is accommodated, and the outlet opening 4.

The armature 5, the piston 6 and the coil 9 are arranged relative to each other in such a manner that some of the windings of the coil 9 encircle a part of the piston 6 as well as a part of the armature 5 arranged inside the piston 6. Accordingly, magnetic flux generated by the coil 9 travels through a side wall of the piston 6 and into the armature 5.

The valve 1 may be operated in the following manner.

In FIG. 1 the valve 1 is shown in a closed position, and the coil 9 is de-energized. Accordingly, the piston 6 is arranged in abutment with the valve seat 11. Thereby a fluid flow from the inlet opening 3 to the outlet opening 4, via the valve seat 11, is prevented. Furthermore, the armature 5 is arranged in abutment with the pilot orifice 12, thereby preventing fluid flow between the interior part of the piston 6, accommodating the armature 5, and the outlet opening 4.

FIG. 2 is an enlarged portion of FIG. 1, showing details of the armature 5 and the piston 6.

When it is desired to open the valve 1, the coil 9 is energized, thereby generating a magnetic field inside the windings of the coil 9. The magnetic field causes the armature 5 to move inside the piston 6 in an upwards direction, i.e. in a direction towards the armature top 8, against the biasing force of the spring 10, and into the position illustrated in FIGS. 3 and 4. FIG. 4 is an enlarged portion of FIG. 3, similar to FIG. 2.

The armature top 8 has a conically shaped end part 8a which can be received in a mating conical recess 5a formed in the armature 5. Thus, when the armature 5 is moved towards the armature top 8 as described above, the conically shaped end part 8a of the armature top 8 is received further in the conical recess 5a of the armature 5. This is clearly visible in FIGS. 3 and 4. This has the consequence that the part of the armature 5 which is arranged inside the windings of the coil 9, has an increasing wall thickness, and the magnetic flux supplied to the armature 5 is thereby increased. Thus, as described above, the valve 1 is a proportional valve.

When the armature 5 is moved as described above, it is moved out of abutment with the pilot orifice 12, as shown in FIGS. 3 and 4. Thereby a fluid passage between the interior of the piston 6, accommodating the armature 5, and the outlet opening 4 is opened, and pressure equalization between these two regions is obtained. The pressure at the inlet opening 3 is then higher than the pressure in the interior part of the piston 6. This pressure difference pushes the piston 6 in an upwards direction, i.e. in a direction towards the armature top 8, and into the position illustrated in FIGS. 5 and 6. FIG. 6 is an enlarged portion of FIG. 5, similar to FIGS. 2 and 4.

When the piston 6 is moved as described above, it is moved out of abutment with the valve seat 11. Thereby fluid is allowed to flow from the inlet opening 3 to the outlet opening 4, via the valve seat 11, i.e. the valve 1 is opened.

The length of the piston 6 along an axial direction, i.e. along the direction of movement of the armature 5 and the piston 6 as described above, is significantly longer than the size of the piston 6 along a transverse direction, i.e. along a direction which is perpendicular to the axial direction. This has the consequence that the guidance of the piston 6 by the armature tube 7, during movements of the piston 6, is good, because tilting and wiggling of the piston 6 is minimised.

A wall part of the piston 6 which faces an inner wall of the armature tube 7, i.e. an outer wall of the piston 6, is provided with a surface pattern 13 of raised and depressed surface portions. The surface pattern 13 has a helical shape, and is similar to a thread. During operation of the valve 1 fluid flows between the inner wall of the armature tube 7 and the outer wall of the piston 6. By providing the outer wall of the piston 6 with the surface pattern 13, the fluid flowing between the inner wall of the armature tube 7 and the outer wall of the piston 6 is accelerated when passing a raised surface portion, and decelerated when passing a depressed surface portion. Thus, the fluid is alternatingly accelerated and decelerated. Thereby a pressure drop is introduced, which reduces the fluid flow along this passage.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

What is claimed is:

1. A magnetic valve comprising:
a valve housing defining an inlet opening and an outlet opening,
a valve seat arranged in an interior part of the valve housing,
a valve closing element arranged in an interior part of the valve housing, said valve closing element being movable relative to the valve seat, in such a manner that the position of the valve closing element relative to the valve seat determines a flow of fluid through the valve from the inlet opening to the outlet opening, via the valve seat,
an armature tube,
a piston arranged movably inside the armature tube, said piston being connected to the valve closing element,
an armature arranged movably at least partly inside the piston, and
a coil arranged externally to the armature tube in such a manner that at least a part of the armature arranged inside the piston is arranged inside the windings of the coil.

2. The valve according to claim 1, wherein the valve is a solenoid valve.

3. The valve according to claim 1, wherein the valve is a proportional valve.

4. The valve according to claim 1, further comprising an armature top arranged to close an end part of the armature tube.

5. The valve according to claim 4, wherein the armature top has an end part facing the armature, said end part having a substantially conical shape arranged to be received in a mating conical recess formed in the armature .

6. The valve according to claim 1, wherein the armature is substantially enclosed by the piston.

7. The valve according to claim 1, wherein the armature is made from a soft magnetic material.

8. The valve according to claim 1, wherein the piston has a length along an axial direction of the armature tube, which is longer than a transverse size of the piston.

9. The valve according to claim 1, further comprising mechanical biasing means biasing the valve closing element in a direction towards or away from the valve seat.

10. The valve according to claim 1, wherein a side wall of the piston facing an inner wall of the armature tube is provided with one or more flow restricting structures.

11. The valve according to claim 10, wherein the flow restricting structure(s) is/are provided by a surface pattern formed in the side wall of the piston.

12. The valve according to claim 1, wherein the piston is provided with a pilot orifice allowing fluid to pass between the outlet opening and the part of the piston where the armature is arranged.

13. The valve according to claim 2, wherein the valve is a proportional valve.

14. The valve according to claim 2, further comprising an armature top arranged to close an end part of the armature tube.

15. The valve according to claim 3, further comprising an armature top arranged to close an end part of the armature tube.

16. The valve according to claim 2, wherein the armature is substantially enclosed by the piston.

17. The valve according to claim 3, wherein the armature is substantially enclosed by the piston.

18. The valve according to claim 4, wherein the armature is substantially enclosed by the piston.

19. The valve according to claim 5, wherein the armature is substantially enclosed by the piston.

20. The valve according to claim 2, wherein the armature is made from a soft magnetic material.
